(19) United States
(12) Patent Application Publication
(10) Pub. No.: US 2022/0027799 A1
(43) Pub. Date: Jan. 27, 2022

(54) CONTENT CLASSIFICATION METHOD AND CLASSIFICATION MODEL GENERATION METHOD

(71) Applicant: SEMICONDUCTOR ENERGY LABORATORY CO., LTD., ATSUGI-SHI, KANAGAWA-KEN (JP)

(72) Inventors: Junpei MOMO, Sagamihara, Kanagawa (JP); Takahiro FUKUTOME, Atsugi, Kanagawa (JP)

(21) Appl. No.: 17/311,730

(22) PCT Filed: Dec. 3, 2019
(86) PCT No.: PCT/IB2019/060377

§ 371 Date: Jun. 8, 2021

(51) Int. Cl. G06N 20/20; G06K 9/62; G06F 3/0482

(52) U.S. Cl. CPC G06N 20/20; G06K 9/6256; G06F 3/0482; G06K 9/628; G06K 9/6277

(57) ABSTRACT

A classification model which classifies contents is provided. Learning contents and contents are included. The learning contents are provided with a first feature and a learning label, and the contents are provided with a second feature. The content classification method includes a step of generating a plurality of first classification models by machine learning using the plurality of learning contents, a step of generating a second classification model with the use of the plurality of first classification models, and a step of providing judgment data for the plurality of contents with the use of the second classification model and performing display on a GUI. The judgment data includes a classification label or a score. The GUI designates a particular numerical range of the score and displays a corresponding content in a list form. Note that features provided for the contents are management parameters (metadata).

### TECHNICAL FIELD

One embodiment of the present invention relates to a content classification method utilizing a computer device, a content classification system, a classification model generation method, and a graphical user interface.

One embodiment of the present invention relates to a computer device. One embodiment of the present invention relates to a method for classifying electronic contents (text data, image data, audio data, or moving image data) utilizing a computer device. In particular, one embodiment of the present invention relates to a content classification system which efficiently classifies a collection of contents with the use of machine learning. One embodiment of the present invention relates to a content classification method, a content classification system, and a classification model generation method which use a graphical user interface that a computer device controls with a program.

### BACKGROUND ART

A user desires to easily classify a collection of contents and extract data regarding a topic that the user designates. However, in the case where a large amount of contents is classified to obtain a content that meets a target condition, content classification results vary depending on individual knowledge, experience, and the like.

Recently, an idea of giving content classification results obtained by classification by individual knowledge and experience to a computer device as teacher data and carrying out machine learning of the content classification method has been proposed. For example, Patent Document 1 discloses an approach of machine learning to determine a document that is highly related to a topic designated by a user.

### REFERENCE

### Patent Document

[Patent Document 1] Japanese Published Patent Application No. 2009-104630

### SUMMARY OF THE INVENTION

### Problems to be Solved by the Invention

There are cases where a collection of contents is classified for purposes. In one embodiment of the present invention, a case where the contents are patents will be described. Patents are given individual patent numbers. Accordingly, contents might be rephrased as patent numbers in the following description. The content classification method described in one embodiment of the present invention focuses on a plurality of management parameters assigned to the patent numbers. Note that the contents are not limited to patent documents. The contents can be data such as text data, image data, audio data, or moving image data.

A content is managed with various kinds of metadata. Metadata refers to not a content itself but data which describes an attribute of the content or data related to the content. For example, a patent number is associated with the scope of claims, an abstract, drawings, and a specification as the contents of the content. Furthermore, patent numbers are given metadata (e.g., evaluation data, the number of days elapsed, and family data), and management using such metadata is conducted. With the metadata, patent numbers are classified by priority. The accuracy or efficiency of classification is likely to vary depending on user's experience or skills although it also depends on the content of the target document, and a vast number of documents need to be classified; thus, there has been a problem of efficiency.

Another problem is that in order to generate a classification model with machine learning, a large amount of learning data needs to be prepared and an excessive burden is placed on users. Another problem is that a variation in the number of classified contents contained in learning data influences the accuracy of the classification model.

In view of the foregoing problems, an object of one embodiment of the present invention is to provide a method for efficiently generating a classification model and classifying data with the use of the classification model. Another object of one embodiment of the present invention is to provide a graphical user interface for generating a classification model in an interactive manner. Another object of one embodiment of the present invention is to provide a program which classifies data having a high probability.

Note that the description of these objects does not preclude the existence of other objects. One embodiment of the present invention does not have to achieve all these objects. Other objects are apparent from and can be derived from the description of the specification, the drawings, the claims, and the like.

### Means for Solving the Problems

A program is stored in a storage device included in a computer device. The program can make a display device included in the computer device display various data via a graphical user interface (GUI below). Note that a user can perform operations such as operating the program, providing data, responding to a database, or giving instructions for machine learning, on the computer device, via the GUI. Furthermore, the program can make the display device display, via the GUI, an arithmetic operation result by machine learning, a learning content or an unclassified content downloaded from a database, or the like. In the following description, the term “content” refers to a learning content, an unclassified content, or a classified content.

The proposed content classification system generates a content classification model utilizing machine learning and classifies an unclassified content with the use of the generated content classification model. For example, a content having a plurality of metadata is used as the learning content. By further being provided with a learning label, the learning content generates a feature vector. In the case where a feature vector is generated, the metadata or the learning label can be handled as a feature of the learning content.

The learning content is handled as teacher data. The classification model can be obtained by machine learning based on learning contents. The classification model obtained here classifies contents having a plurality of metadata. Note that the number of classification categories may be two, three, or more in accordance with the user's purpose. By utilizing the classification model, the user can classify all the documents in a time shorter than the time taken to judge all the documents manually or visually.

Note that the learning content can be downloaded from a database that stores learning contents. Alternatively, a learning content stored in the storage device of the computer device can be used. The learning content may be managed, including a learning label. Furthermore, a classification model stored in a database may be downloaded. Alternatively, a classification model stored in the storage device of the computer device may be used.

One embodiment of the present invention includes learning contents and contents; the learning contents are provided with a first feature and a learning label, and the contents are provided with a second feature. The content classification method includes a step of generating a plurality of first classification models by machine learning using the plurality of learning contents, a step of generating a second classification model with the use of the plurality of first classification models, and a step of providing judgment data for the plurality of contents with the use of the second classification model and performing display on a graphical user interface.

One embodiment of the present invention includes learning contents and contents; the learning contents are provided with a first feature and a learning label, and the contents are provided with a second feature. The content classification method includes a step of generating a plurality of first classification models by machine learning using the plurality of learning contents, a step of calculating average values from outputs of the plurality of first classification models; a step of generating a second classification model with the use of the plurality of average values; and a step of providing judgment data for the plurality of contents with the use of the second classification model and performing display on a graphical user interface.

One embodiment of the present invention includes learning contents and contents; the learning contents are provided with a first feature and a learning label, and the contents are provided with a second feature. The content classification method includes a step of generating a plurality of first classification models by machine learning using the plurality of learning contents, a step of evaluation by the plurality of first classification models in accordance with their respective first evaluation criteria, a step of evaluation by the plurality of first classification models in accordance with their respective second evaluation criteria, a step of generating a second classification model from evaluation results in accordance with the plurality of first evaluation criteria and evaluation results in accordance with the second evaluation criteria, and a step of providing judgment data for the plurality of contents with the use of the second classification model and performing display on a graphical user interface.

In the above-described structure of the content classification method, the first evaluation criteria are preferably precision, and the second evaluation criteria are preferably sensitivity.

In each of the above-described structures, the content classification method preferably includes a step of generating the first classification models with the use of any of the learning contents.

In each of the above-described structures, the content classification method preferably includes further providing the learning contents with classification data and a step of selecting a content having the judgment data which is the same as the classification data from the plurality of contents which are provided with classification labels with the use of an output of the second classification model and displaying the content having the judgment data on the graphical user interface.

In each of the above-described structures of the content classification method, features provided for the learning contents and the contents are preferably management parameters.

In each of the above-described structures of the content classification method, the judgment data preferably includes a classification label or a score.

In each of the above-described structures, the content classification method preferably includes a step in which the graphical user interface designates a particular numerical range of the score and displays a corresponding content in a list form.

### Effect of the Invention

One embodiment of the present invention can provide a method for classifying data with high accuracy. One embodiment of the present invention can provide a user interface which classifies data with high accuracy. One embodiment of the present invention can provide a program which classifies data with high accuracy.

Moreover, one embodiment of the present invention can provide a user with an interactive interface for generating a classification model utilizing machine learning, whereby a burden such as preparation of teacher data or evaluation of learning results on users can be reduced.

Note that the effects of one embodiment of the present invention are not limited to the effects listed above. The effects listed above do not preclude the existence of other effects. Note that the other effects are effects that are not described in this section and will be described below. The other effects not described in this section will be apparent from the description of the specification, the drawings, and the like and can be derived as appropriate from the description by those skilled in the art. One embodiment of the present invention has at least one effect of the effects listed above and/or the other effects. Therefore, one embodiment of the present invention does not have the effects listed above in some cases.

### BRIEF DESCRIPTION OF THE DRAWINGS

FIG. 1 is a flow chart showing a classification method.

FIG. 2 is a flow chart showing a classification method.

FIG. 3 is a diagram showing a connection between a classification system 100 and a network.

FIG. 4 is a block diagram showing a classification system.

FIG. 5A and FIG. 5B are diagrams showing graphical user interfaces.

FIG. 6 is a diagram showing a classification model generation method.

FIG. 7 is a diagram showing a classification model generation method.

FIG. 8 is a diagram showing a classification model generation method.

FIG. 9 is a diagram showing a graphical user interface.

FIG. 10 is a diagram showing a graphical user interface.

### MODE FOR CARRYING OUT THE INVENTION

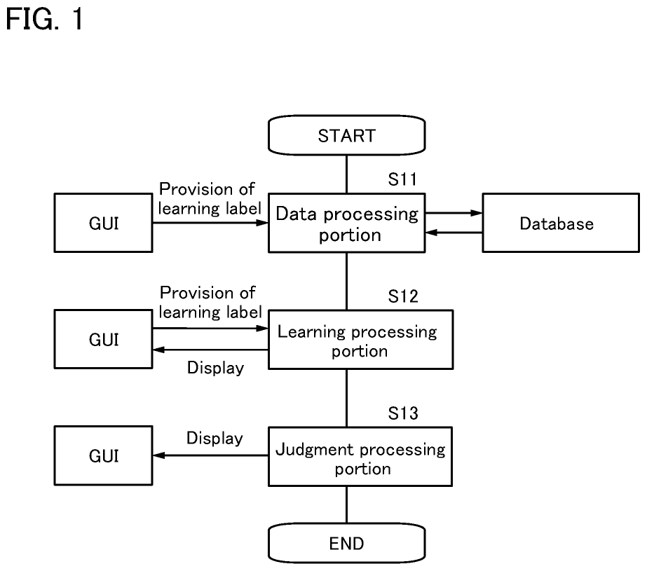

In this embodiment, a content classification method is described with reference to FIG. 1 to FIG. 10.

The content classification method described in this embodiment is controlled by a program which operates on a computer device. The program is stored in a memory included in the computer device or a storage. Alternatively, the program is stored in a computer which is connected via a network (e.g., LAN (Local Area Network), WAN (Wide Area Network), or the Internet) or a server computer including a database.

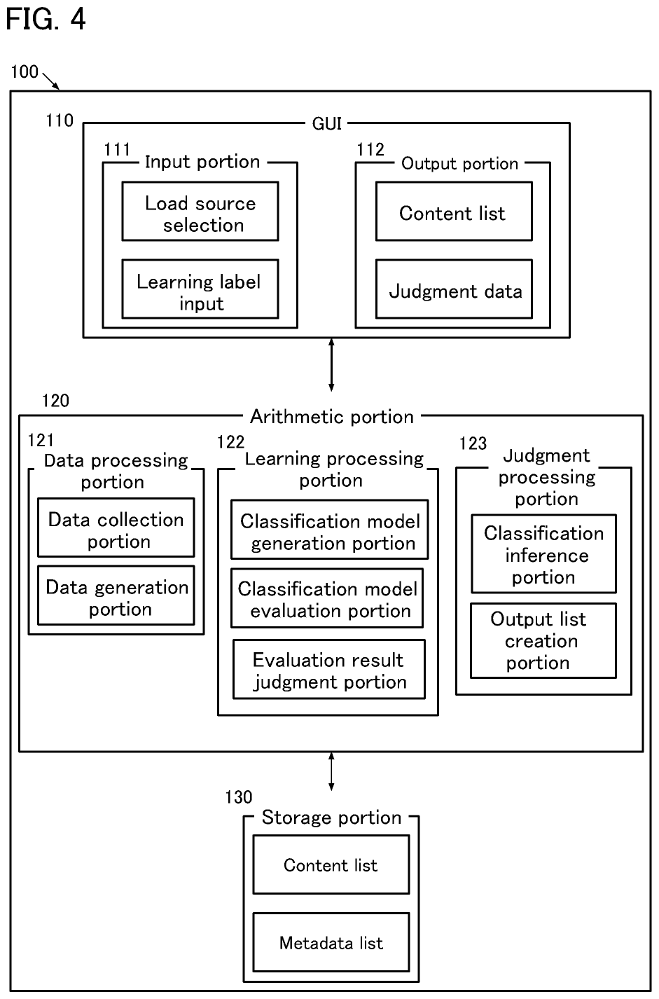

Note that a display device included in the computer device can display data that a user gives to the program and a result of an arithmetic operation of the data by an arithmetic device included in the computer device. The structure of the device will be described in detail with reference to FIG. 4.

For example, the data displayed on the display device follows a display format of a list, which makes the data easily recognizable by a user and improves the operability. Thus, the description is made using a GUI as an interface for a user to easily communicate with the program included in the computer device via the display device.

The user can utilize the content classification method included in the program via the GUI. The user can easily perform a content classification operation with the GUI. With the GUI, the user can easily judge a content classification result visually. Furthermore, the user can easily operate the program via the GUI. Note that the content refers to data such as text data, image data, audio data, or moving image data.

Next, the content classification method using the GUI is described following a GUI operation procedure. First, a data processing portion is described. The data processing portion includes a data collection portion and a data generation portion. For example, the data collection portion obtains a file formed of a plurality of contents from a database via the GUI. Furthermore, the data generation portion can generate learning contents in such a manner that the user provides learning labels to the contents via the GUI. Alternatively, learning contents provided with learning labels may be obtained from a database. Note that the plurality of contents refer to a file stored in a memory included in the computer device or a storage or data stored in a database, a computer, a data server, or the like connected to a network.

Accordingly, it is preferable that a plurality of learning contents or a plurality of unclassified contents be stored in the database in a list form. Note that the learning contents and the unclassified contents are provided with a plurality of features and learning labels. The learning labels can be modified via the GUI by the user. In the case where the learning labels are provided for the learning contents, the learning contents provided with the learning labels can be stored in the database.

The learning contents can include a test content which is not provided with a learning label. The test content can be used to test a classification model generated with the learning contents.

As an example, a case where the contents are patent numbers is described. A patent number is provided with a plurality of metadata as features of the patent number. The metadata are, for example, evaluation data, the number of days elapsed, the number of families, the state of a family, the application type, the life, the number of pending applications in a family, the number of abandoned applications in a family, costs, the number of inventors, field, the number of claims, or the like. In other words, the metadata are management parameters for the contents. Note that a family means a patent family, for example.

Next, a learning processing portion is described. The learning processing portion has a step of generating a classification model using learning contents. The learning processing portion includes a classification model generation portion or a classification model evaluation portion.

The classification model generation portion can generate a classification model. The classification model generation portion has a step of generating a plurality of first classification models by machine learning using a plurality of learning contents and a step of generating a second classification model by using the plurality of first classification models. The output values of the first classification models or the second classification model can be displayed on the GUI. The user can provide (or modify) learning labels of the first classification models on the basis of the output value. Alternatively, the user can add a new learning content to the output value.

The classification model evaluation portion evaluates the classification model generated by the classification model generation portion with the use of a test content. In the case where the test content is inferred with the classification model, the classification model outputs an inference result as judgment data. The GUI can display each evaluation content provided with the judgment data.

Note that the user can judge the output result from the classification model evaluation portion, modify the learning label if necessary, and update the classification model in the classification model generation portion. Alternatively, a learning content can be added to update the classification model in the classification model generation portion.

Next, a judgment processing portion is described. The judgment processing portion includes a classification inference portion and a list generation portion. For example, the classification inference portion infers and classifies a plurality of unclassified contents with the use of the first learning models and the second learning model generated by the classification model generation portion. The classification models provide an inference result as judgment data for each content.

The list generation portion can generate a list in a form that a user desires from the contents provided with the judgment data and display the list on the GUI. For example, in the case where contents are each managed on the application country basis, the application country can be classification data. In the case where the application country is used as the classification data, classification models that differ between the application countries are preferably generated. Note that the classification data is not limited to the application country. For example, the classification data can be one of the metadata included in the contents.

The case where the metadata is used as the classification data is described. For example, the state of the patent family may be used as the classification data. In some cases, patent numbers are provided with metadata such as patent numbers of the parent applications, patent numbers of the divisional applications, or the like. Different classification models can be generated to correspond to the state where divisional application is possible from the patent number of the parent application, the state where divisional application is impossible from the patent number of the parent application, the state where the patent right of the patent number of the parent application is maintained, the state where the patent right of the patent number of the parent application is forfeited, the state where further divisional application is possible from the patent number of the divisional application, the state where further divisional application is impossible from the patent number of the divisional application, the state where the patent right of the patent number of the divisional application is maintained, the state where the patent right of the patent number of the divisional application is forfeited, or the like; and the classification models can be used for inferences.

In other words, the judgment processing portion can infer a plurality of unclassified contents with the classification models. A step of providing the inference result as judgment data for each content and displaying the result on the GUI is included. The judgment data includes at least a classification label and a score (probability). Furthermore, a step in which the GUI designates a particular numerical range of the score and displays the corresponding content in a list form is included.

An example different from the above-described classification model generation portion is described. The classification model generation portion has a step of generating a plurality of first classification models by machine learning with the use of a plurality of learning contents, a step of calculating average values from the outputs of the plurality of first classification models, and a step of generating the second classification model using the plurality of average values. Note that the output values of the first classification models or the second classification model can be displayed on the GUI. The user can modify the learning labels of the first classification models on the basis of the output values. Alternatively, the user can add a learning content to the output values. Note that the average value means calculation using any one of arithmetic mean calculation, geometric mean calculation, and harmonic mean calculation.

The second classification model is generated using the plurality of average values. In the second classification model, the outputs of the first classification models are averaged, whereby the influence of a noise component such as an outlier of the learning contents can be reduced.

Next, an example different from the above-described classification model generation portion is described. The classification model generation portion has a step of generating a plurality of first classification models by machine learning using a plurality of learning contents, a step of evaluation by the plurality of first classification models in accordance with their respective first evaluation criteria, a step of evaluation by the plurality of first classification models in accordance with their respective second evaluation criteria, and a step of generating the second classification model from evaluation results in accordance with the plurality of first evaluation criteria and evaluation results in accordance with the second evaluation criteria. Note that the output values of the first classification models or the second classification model can be displayed on the GUI. The user can modify the learning labels of the first classification models on the basis of the output values. Alternatively, the user can add a learning content to the output values. Note that the first evaluation criteria are the accuracy of the confusion matrix, and the second evaluation criteria are the sensitivity of the confusion matrix.

With the use of the results of evaluation on the outputs of the plurality of first classification models in accordance with the first evaluation criteria and the second evaluation criteria, the second classification model is generated. Note that the accuracy of the confusion matrix for the first evaluation criteria can also be referred to as the precision with respect to learning labels. The sensitivity of the confusion matrix for the second evaluation criteria can also be referred to as the recall with respect to learning labels. Thus, the generated classification model can include the precision and the recall of the plurality of first classification models. The second classification model generated using the plurality of first classification models has increased classification accuracy.

In the above-described classification model generation portion, the second classification model may be generated with the use of generated m (m represents a natural number) first classification models, for example.

In the case where the above-described classification model generation portion includes k (k represents a natural number) learning contents, the first classification models can generate k or less arbitrary learning contents. Furthermore, in the case where k learning contents are selected, the arbitrary learning contents can include two different learning models. Moreover, learning contents provided with k different numbers can be used q by q (q represents a natural number) in the numerically sorted order to generate the first classification models.

The program can let the contents read from the database be displayed on the GUI. The contents preferably include listed metadata. The GUI displays the contents in accordance with the display format the GUI possesses. Note that the listed metadata provided for the contents are preferably managed on the record unit basis. For example, each record consists of ID (Identification), a content (image data, audio data, or moving image data), metadata, and the like which are associated with a number.

In this specification, machine learning is performed focusing on metadata, and classification models are generated by the machine learning. The classification models analyze the metadata and classify contents in a feature vector form.

Furthermore, in the above-described content classification method, classification by machine learning which does not use learning labels as teacher data can be performed. For example, an algorithm such as K-means or DBSCAN (density-based spatial clustering of applications with noise) can be used for the classification model.

Furthermore, the program can generate classification models by machine learning using learning contents provided with a plurality of metadata and learning labels. For the classification model, an algorithm such as a decision tree, Naive Bayes, KNN (k Nearest Neighbor), SVM (Support Vector Machines), perceptron, logistic regression, or a neural network can be used.

Moreover, the program can switch the classification model in accordance with the number of learning contents. For example, when the number of learning contents is small, a decision tree, Naive Bayes, or logistic regression may be used; when the number of learning contents is more than or equal to a certain value, SVM, random forests, or a neural network may be used. Note that the classification model used in this embodiment uses random forests, which is one algorithm of a decision tree. Furthermore, random sampling or cross validation can be used as the metadata selection method, the learning content selection method, or the first classification model selection method. Alternatively, selection can be performed q by q in the provided-number sort order.

Next, the content classification method is described with reference to the drawings. FIG. 1 is a flowchart showing the content classification method of one embodiment of the present implementation. The content classification method is controlled by the program which operates on the computer device. Accordingly, by including the data processing portion, the learning processing portion, or the judgment processing portion, the program can classify contents. The program can classify contents as the user requests via the GUI. That is, the contents processed in each of the above-described processing portions correspond to steps in the program.

In Step S11, the user can give an instruction to load a file including contents via the GUI. The file is stored in the database included in the data processing portion. Note that the file includes a learning content, an unclassified content, or the like.

Accordingly, a plurality of learning contents or a plurality of unclassified contents in a list form are preferably stored in the database. The user can provide or modify a learning label of a learning content displayed on the GUI. Note that the file can include a test content which is not provided with a learning label.

Step S12 is the learning processing portion which generates a classification model using the loaded file. With the generated classification model, a test content can be evaluated, and the evaluation result can be displayed on the GUI. The user can give an instruction such as modification of a learning label or addition of a learning content on the basis of the evaluation result.

Note that the user can predict a change over time of metadata included in the learning content and update the metadata. In the case where the user updates the metadata, the classification model can include a change over time of the classification model. Thus, the user can obtain a change over time of the content classification. The classification model can classify contents into a group of contents whose values are expected to increase and a group of contents whose values are expected to decrease.

Step S13 is the judgment processing portion. With the classification model generated in Step S12, an unclassified content is inferred. The classification model can provide the unclassified content with judgment data on the basis of the inference result. The judgment processing portion can display the content provided with the judgment data on the GUI in the form the user desires. The judgment data includes at least a classification label and a score. Furthermore, the GUI can designate a particular numerical range of the score and display the corresponding content.

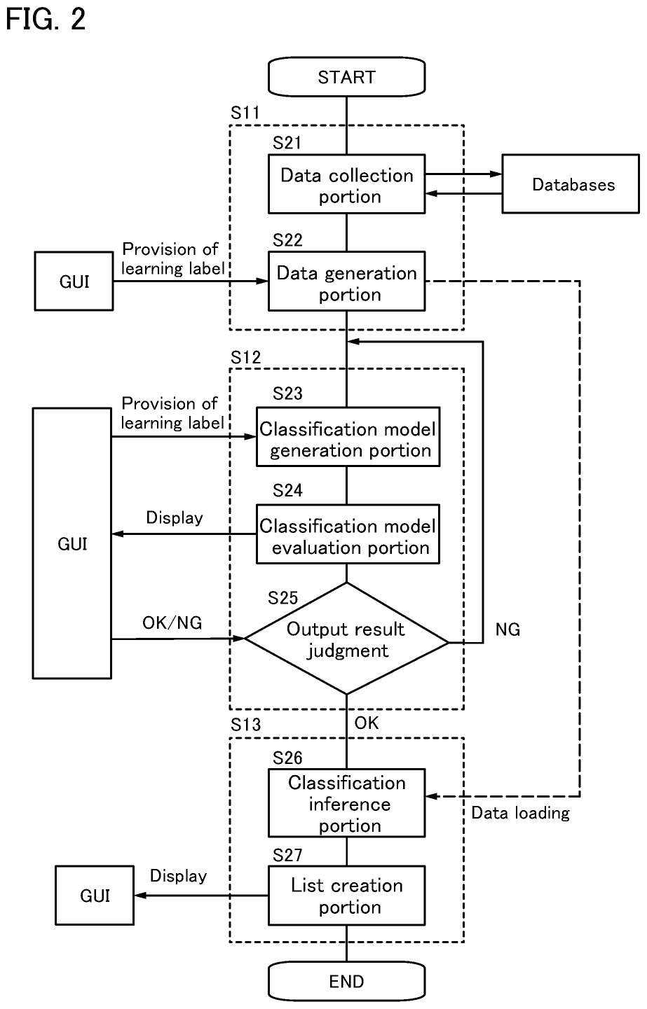

Next, the flowchart of FIG. 1 is described in more detail with reference to FIG. 2. First, the details of Step S11 is described. The data processing portion in Step S11 includes the data collection portion in Step S21 and the data generation portion in Step S22.

The data collection portion in Step S21 is described. The data collection portion in Step S21 can load a file from a database. Note that metadata, contents, or the like can be managed with different databases. Metadata may vary depending on the company, organization, or user who handles the contents. Accordingly, the data collection portion has a function of collecting metadata regarding the content from different databases. Note that the databases can be located in different buildings, areas, or countries.

Next, the data generation portion in Step S22 is described. The data generation portion can manage contents and metadata on the record unit basis. For example, each record consists of ID, a content (image data, audio data, or moving image data), metadata, or the like which is associated with a number. Furthermore, the user can generate a learning content by providing a learning label for the content displayed on the GUI.

Next, the details of Step S12 are described. The learning processing portion in Step S12 includes the classification model generation portion in Step S23, the classification model evaluation portion in Step S24, and output result judgment processing in Step S25.

The classification model generation portion in Step S23 is described. The classification model generation portion can generate a content classification model. The classification model generation portion can generate a plurality of first classification models by machine learning using a plurality of learning contents. The second classification model can be generated with the use of the plurality of first classification models. The GUI can display output values of the first classification models or the second classification model.

After the output result judgment processing in Step S25, which is described later, the user can provide (or modify) learning labels of the first classification models on the basis of the output value. Alternatively, the user can add a new learning content to the output value. A change over time of metadata included in the learning content can be predicted and the metadata can be updated. For the effects obtained by the metadata update by the user, the description of Step S12 can be referred to.

Next, the classification model evaluation portion in Step S24 is described. The classification model evaluation portion can evaluate the classification model generated by the classification model generation portion with the use of the test content. The classification model outputs a test-content inference result as judgment data. The GUI can display each evaluation content provided with the judgment data.

Next, the output result judgment processing in Step S25 is described. For example, the user can judge the output result from the classification model evaluation portion in Step S24 and judge that the content classification model has sufficiently learned. The user gives an instruction of completion of classification model generation (OK) to the GUI. For example, the user can judge that the content classification model has not learned sufficiently (NG). The user goes back to Step S23 and changes the learning label, adds a learning content, or updates metadata, for example, to update the classification model.

Then, the details of Step S13 is described. The judgment processing portion in Step S13 includes the classification inference portion in Step S26 and a list creation portion in Step S27.

The classification inference portion in Step S26 is described. The classification inference portion infers and classifies a plurality of unclassified contents with the use of the first learning models and the second learning model generated by the classification model generation portion. Note that unclassified contents generated by the data generation portion in Step S22 are provided for the classification inference portion. The classification models provide an inference result as judgment data for each content.

The list creation portion in Step S27 is described. The list generation portion can list the contents provided with the judgment data in the form the user desires and display the contents on the GUI. Note that each content may be provided with classification data that is different from metadata. For example, in the case where a learning content is provided with classification data, the generated classification model can generate different classification models for different classification data. Alternatively, one of the metadata included in the contents can be used as classification data.

Note that the judgment data includes at least a classification label and a score. Furthermore, the GUI can designate a particular numerical range of the score and display the corresponding content in a list form on the GUI.

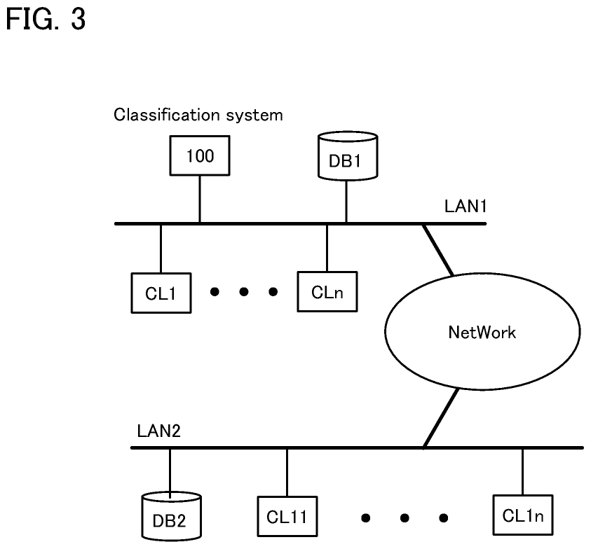

FIG. 3 is a diagram showing a connection between a classification system 100 having the above-described content classification method and a network (NetWork).

The classification system 100 is connected to a communications network LAN1. A database DB1, client computers CL1 to CLn (n is a natural number), or the like is connected to the communications network LAN1. Furthermore, the communications network LAN1 can be connected to a communications network LAN2 via the network. As the network, the Internet, the communications network WAN, or satellite communication can be used. A database DB2, client computers CL11 to CL1n, or the like is connected to the communications network LAN2.

The classification system 100 is capable of content generation, content classification, model generation, and classification of unclassified contents with the use of files including contents stored in the database DB1, the database DB2, the client computers CL1 to CLn, or the client computers CL11 to CL1n.

Furthermore, the user can give an instruction to the GUI with the program which operates on the classification system 100. For example, the user can generate the above-described classification model with the use of data in a database located in a different country through the Internet and classify unclassified contents. That is, contents or metadata may be stored in a different database or a different client computer.

Note that the GUI can display a classification result generated by the classification system 100 stored in a storage device of a computer device in the database DB1, the database DB2, the client computers CL1 to CLn, or the client computers CL11 to CL1n.

FIG. 4 is a block diagram showing the classification system 100 illustrated in FIG. 3. The classification system 100 includes a GUI (Graphical User Interface) 110, an arithmetic portion 120, and a storage portion 130. The GUI 110 includes an input portion 111 and an output portion 112. The input portion 111 has a function of selecting a content load source and a function of inputting a learning label. The output portion 112 has a function of displaying a content list loaded from a database or the like and a function of displaying judgment data which is output by the classification model. Note that metadata included in the displayed content can be modified by the user via the GUI.

The arithmetic portion 120 includes a data processing portion 121, a learning processing portion 122, and a judgment processing portion 123. The data processing portion 121 includes the data collection portion and the data generation portion. The learning processing portion 122 includes the classification model generation portion where a classification model is created and the classification model evaluation portion where a classification model is classified. Note that the output result from the classification model evaluation portion has a function of evaluation result judgment processing in which judgment is performed by a user. The judgment processing portion 123 includes the classification inference portion and an output list creation portion which lists the result of classification by the classification inference portion. In the arithmetic portion 120, the program stored in the storage portion included in the computer device performs an arithmetic operation with a microprocessor. Note that the program can perform an arithmetic operation with a DSP (Digital signal Processor) or a GPU (Graphics Processing Unit).

The storage portion 130 temporarily stores generated contents and metadata loaded from a database or the like in a list form.

The storage portion 130 can use a DRAM (dynamic random access memory) including a 1T (transistor) 1C (capacitor) type memory cell, for example. As the transistor used in the memory cell of the DRAM, an OS transistor may be used. The OS transistor is a transistor including a metal oxide in its semiconductor layer. A memory device which uses an OS transistor in its memory cell is referred to as “OS memory”. Here, a RAM including a 1T1C type memory cell, which is regarded as an example of an OS memory, is referred to as “DOSRAM (Dynamic Oxide Semiconductor RAM)”.

The OS transistor has an extremely low off-state current. Thus, the refresh frequency of a DOSRAM can be reduced; accordingly, the power needed for refresh operation can be reduced. Here, the off-state current refers to a current that flows between the source and the drain when the transistor is in an off state. For an n-channel transistor, for example, when the threshold voltage of the transistor is approximately 0 V to 2 V, a current that flows between the source and the drain when a voltage between the gate and the source is negative can be referred to as an off-state current.

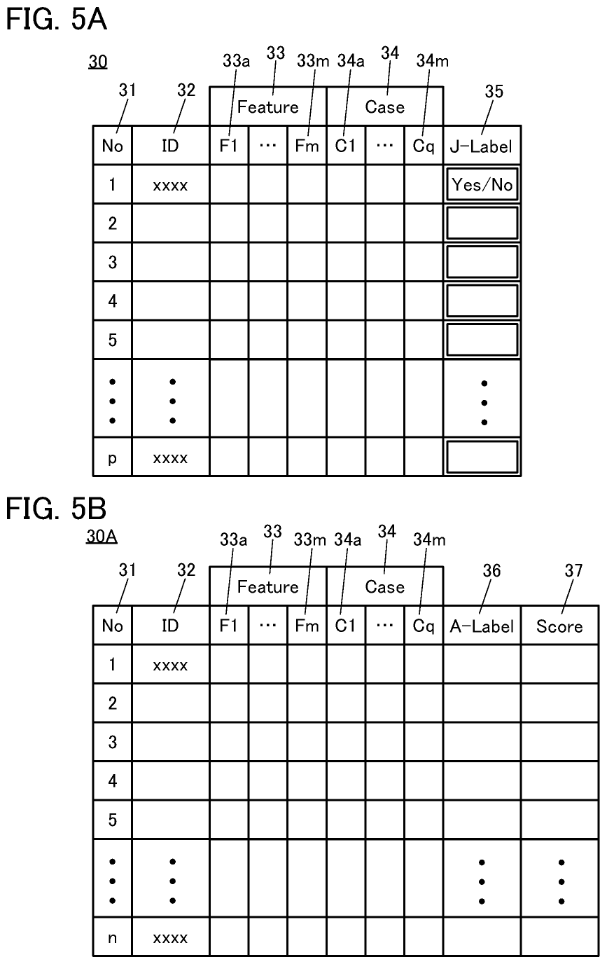

FIG. 5A is a diagram showing a structure of a GUI 30. The GUI 30 shows a management screen which displays p learning contents in a list form, as an example. The learning contents are managed on the record unit basis. The record includes a number (No) 31, a content (ID) 32, metadata showing features (Feature) 33 (metadata (F1) 33a to metadata (Fm) 33m), classification data (Case) 34 (classification data (C1) 34a to classification data (Cq) 34q), a learning label (J-Label) 35, and the like. Although the learning label 35 gives either of two values, “Yes” and “No”, in FIG. 5A as an example, the learning label 35 is not limited to two values and may be three or more values.

FIG. 5B is a diagram showing a structure of a GUI 30A. The GUI 30A shows a management screen which displays judgment data, which is obtained by inference of n unclassified contents in an evaluation inference portion, in a list form. Like the learning contents, the unclassified contents include the number 31, the content 32, the metadata 33, and the classification data 34. Furthermore, each record is provided with a classification label (A-Label) 36 and a score (Score) 37 as judgment data.

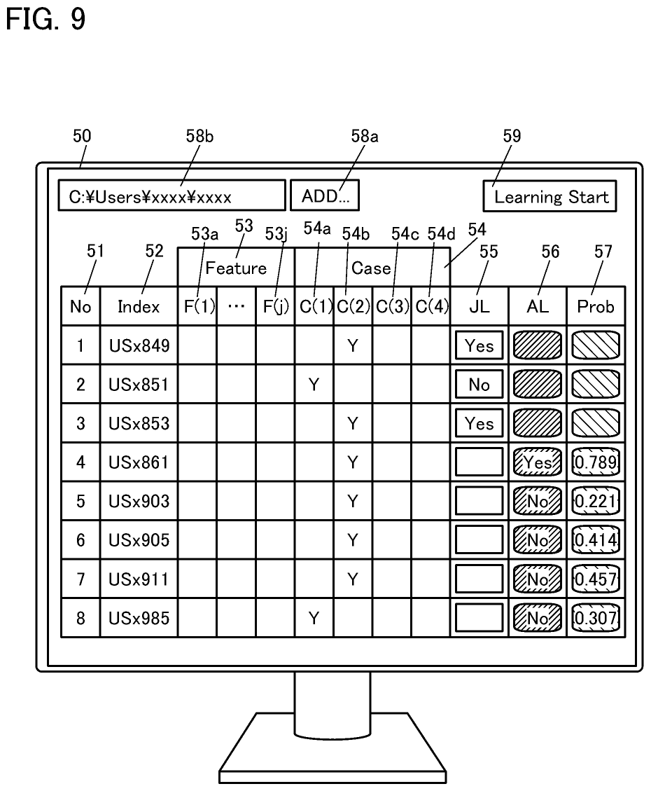

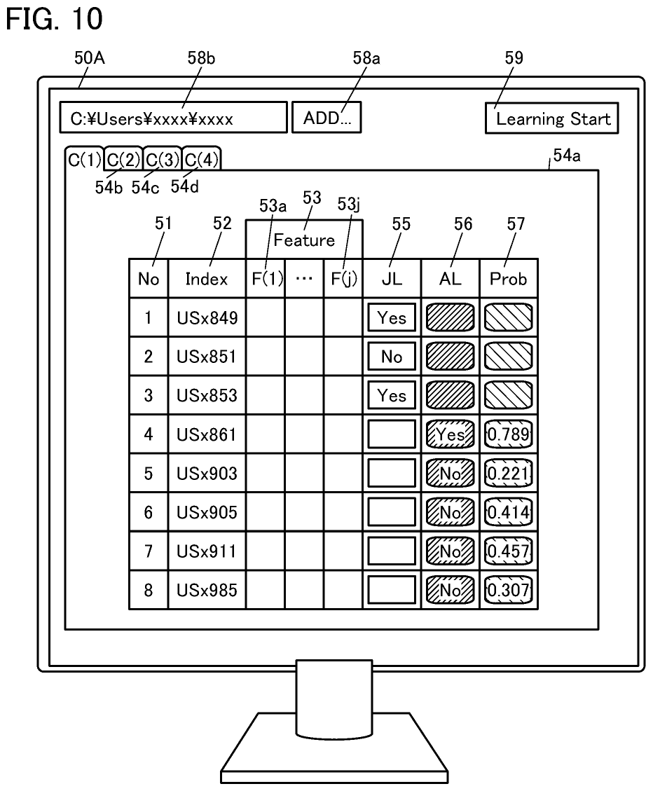

Note that the GUI 30 and the GUI 30A can conduct management on the same display screen. In FIG. 9 or FIG. 10 which are described later, a display example of a GUI which can display learning contents and judgment data on the same management screen is illustrated.

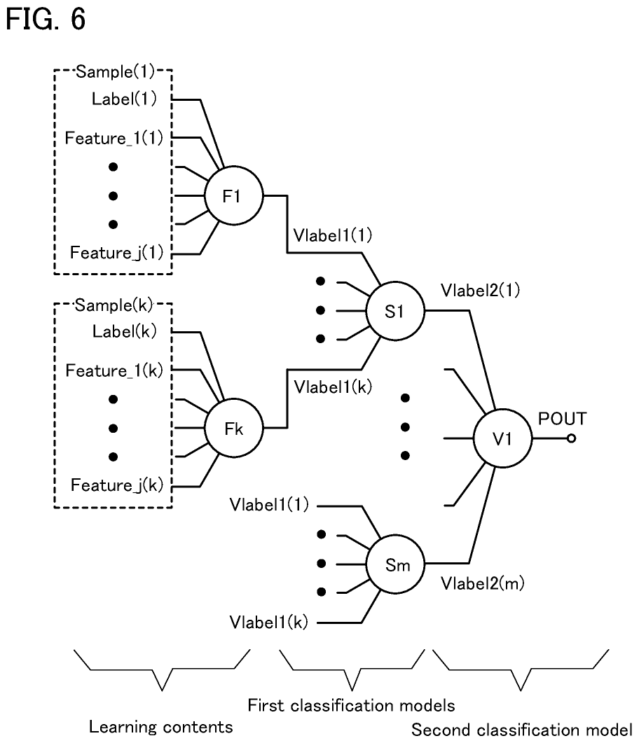

FIG. 6 is a diagram showing a classification model generation method using a plurality of features Feature associated with the above-described learning contents Sample by machine learning. Each of the features Feature shows any one of metadata and corresponds to a management parameter for content management. In this embodiment, the classification model generation method is described using an arithmetic portion F, an arithmetic portion S, an arithmetic portion V, first classification models, and a second classification model.

Each of a learning content Sample(1) to a learning content Sample(k) is provided with j features Feature and a learning label Label. For example, an arithmetic portion F1 can generate a feature vector Vlabel1(1) in a computer-processable form from the learning content Sample(1). Furthermore, an arithmetic portion Fk can generate a feature vector Vlabel1(k) in a computer-processable form from the learning content Sample(k). Note that the arithmetic portion F1 can generate the feature vector Vlabel1(1) by providing different weight coefficients to the respective features. Furthermore, the feature vector Vlabel1(1) can be generated using randomly selected j or less features Feature.

Next, a plurality of first classification models are generated. An arithmetic portion S1 to an arithmetic portion Sm correspond to the first classification models which are different from each other. For example, the arithmetic portion S1 can generate the first classification model with the use of the feature vector Vlabel1(1) to the feature vector Vlabel1(k). Note that the number of feature vectors Vlabel1 provided for the arithmetic portion S1 is less than or equal to k. In a different example, the first classification model can be generated by the arithmetic portion Sm using the feature vector Vlabel1(1) to the feature vector Vlabel1(k) different from the above. Thus, two different first classification models can each include k or less feature vectors Vlabel1 and can include one same feature vector Vlabel1.

k learning contents Sample selected to generate the first classification model may be selected at random or in the sort order based on the number provided for the learning contents. In the case where learning contents are selected at random, the first classification model can include a variation of learning contents. Furthermore, in the case where selection is performed in the sort order based on the number provided for the learning contents, the first classification model can include a tendency in accordance with the number provided chronologically or on the basis of any one feature of the metadata.

Accordingly, the first classification model can generate a feature vector Vlabel2 with the use of the feature vectors Vlabel1 generated from the learning content Sample(1) to the learning content Sample(k).

The second classification model is generated by an arithmetic portion V1. For example, the arithmetic portion V1 has a step of generating the second classification model with the use of m feature vectors Vlabel2. Note that the second classification model can generate a classification model having a different feature with the use of a feature vector Vlabel2(1) to a feature vector Vlabel2(m).

Thus, the second classification model can output an output value POUT with the use of feature vectors Vlabel1 generated from the learning content Sample(1) to the learning content Sample(k). The GUI can display the output value POUT. Note that the output value POUT includes the classification label and the score, which are judgment data. Thus, the second classification model can classify contents. In addition, the second classification model can provide judgment data for each content.

In order to make an inference using the classification model illustrated in FIG. 6, an unclassified content is provided as the learning content Sample of the classification model, so that the judgment result is obtained. Note that unlike the learning content, the unclassified content is not provided with a learning label.

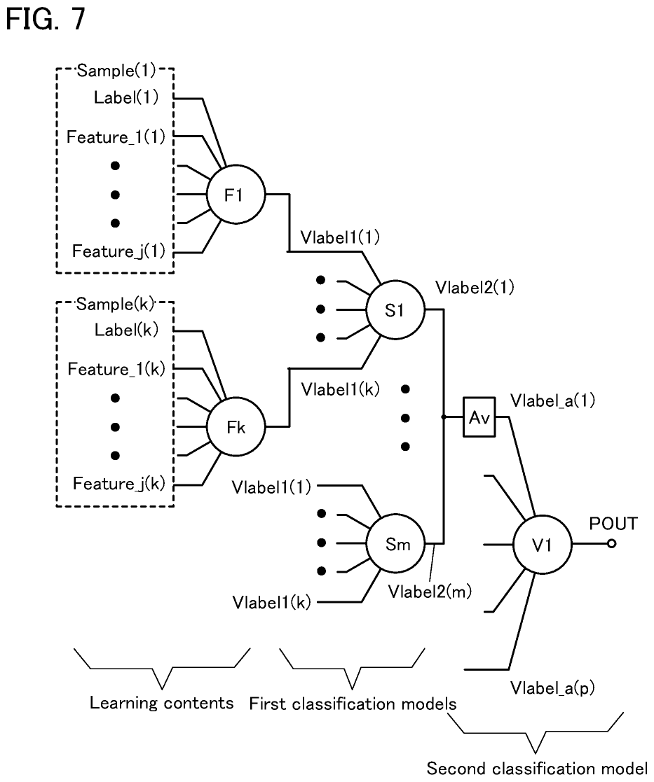

FIG. 7 is a diagram showing a classification model generation method different from that of FIG. 6. Points of FIG. 7 different from those of FIG. 6 are described; and in the structure of the invention (or the structure in an example), the same portions or portions having similar functions are denoted by the same reference numerals in different drawings, and a repetitive description of such portions is omitted.

In FIG. 7, an average value Av of m feature vectors Vlabel2 is calculated, and a feature vector Vlabel_a is generated. The second classification model can be generated using p feature vectors Vlabel_a. The second classification model can generate a classification model having a different feature by calculating the average value Av of m feature vectors Vlabel2. The generated classification model can precisely classify contents.

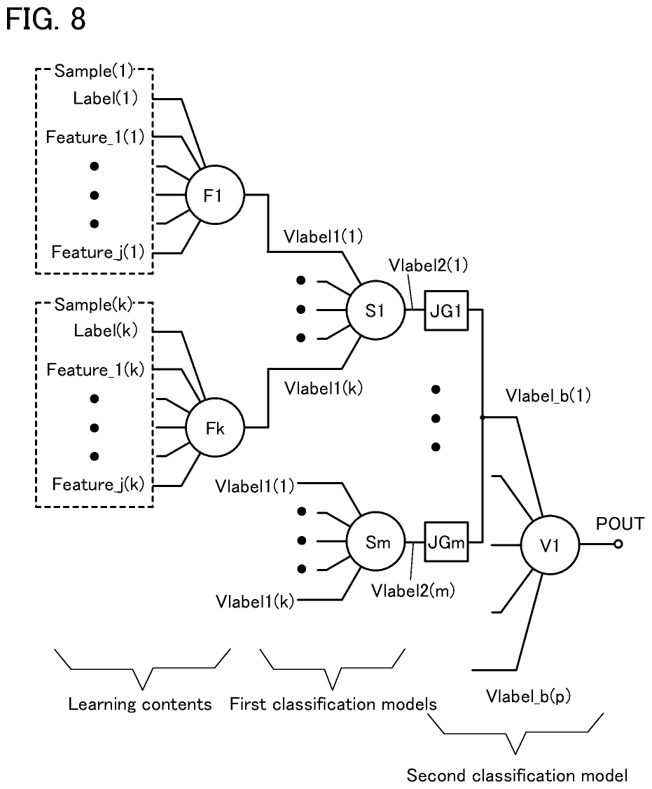

FIG. 8 is a diagram showing a classification model generation method different from that of FIG. 7. Points of FIG. 8 different from those of FIG. 7 are described; and in the structure of the invention (or the structure in an example), the same portions or portions having similar functions are denoted by the same reference numerals in different drawings, and a repetitive description of such portions is omitted.

In FIG. 8, evaluation criteria for evaluating m feature vectors Vlabel2 are provided for evaluation judgment portions JG. For example, precision is provided for an evaluation judgment portion JG1 as the first evaluation criteria, and each feature vector Vlabel2(1) can be evaluated. Next, sensitivity is provided for the evaluation judgment portion JG1 as the second evaluation criteria, and each feature vector Vlabel2(1) can be evaluated. The evaluation judgment portion JG1 outputs an evaluation result Vlabel_b(1)

The second classification model is generated using the evaluation result Vlabel_b(1) to an evaluation result Vlabel_b(p). For example, a plurality of feature vectors Vlabel2 may be evaluated in accordance with first evaluation criteria and second evaluation criteria which are different from each other or may be evaluated in accordance with the same evaluation criteria. Although not illustrated in FIG. 8, an average value of the evaluation results Vlabel_b can be calculated in accordance with the first evaluation criteria and the second evaluation criteria in a manner similar to that of FIG. 7.

The second classification model can generate a classification model having a different feature with the use of the evaluation results of m feature vectors Vlabel2. The generated classification model can precisely classify contents.

FIG. 9 is a diagram showing a GUI 50. The GUI 50 includes a display region of contents (a learning content, an unclassified content, a classified content), an icon 58a where a download source for a file including contents is selected, a text box 58b where data of the address at which the selected file is stored is displayed, and an icon (Learning Start) 59 for executing machine learning.

An example in which eight records are loaded on the display region is illustrated as an example. Each record includes constituent elements of a number (No) 51, an ID (Index) 52, features (Feature) 53, classification data (Case) 54, a learning label (JL) 55, a classification label (AL) 56, and a score (Prob) 57. As detailed data of the features 53, a feature F(1) 53a to a feature F(j) 53j can be displayed. Note that j is a natural number. Furthermore, as detailed data of the classification data 54, classification data C(1) 54a to classification data C(4) 54d can be displayed. Note that kinds of classification data that can be expressed by a natural number can be included.

FIG. 9 shows an example in which classification results of learning contents and unclassified contents by a classification model are displayed on the GUI 50.

For example, record numbers No1 to No3 correspond to learning contents. The learning contents are provided with learning labels, and the record numbers No1 to No3 are provided with classification data.

Record numbers No4 to No8 correspond to classified contents. The classified contents are provided with the classification label 56 and the score 57. Note that FIG. 9 displays the results of classification of the record numbers No4 to No7 with the use of the classification model which is obtained by learning of the record numbers No1 and No3. As an example, a result of classification of the record number No8 with the use of a classification model which is obtained by learning of the record number No2 is displayed. Although only eight records are displayed due to space limitations in FIG. 9, a plurality of kinds of records can be handled.

In the case of handling a large number of records, there is a display problem. Therefore, a sort function is preferably provided for the classification label 56 or the score 57. For example, the GUI can select and display the judgment result “Yes” of the classification label 56 as the sort condition. Furthermore, the GUI can designate and display a numerical range of the score 57. In the case where the above-described sort conditions are provided for the GUI, the GUI can classify and display a content having the same feature as a learning content provided with teacher data.

For example, a case where the contents are patent numbers is described. Patent numbers are provided with a plurality of metadata. For the patent number of a patent whose right is maintained, a learning label “Yes” is provided. For the patent number of a patent whose right is abandoned, a learning label “No” is provided. Then, machine learning is executed and a classification model is generated.

The above-described classification model can provide judgment data for the unclassified contents. As judgment data, the classification label 56 and the score 57 are displayed. For example, a user provides “No” as the classification label 56, using the sort function. Furthermore, “0.8” to “1.0” is set as the score 57. By providing the above-described sort conditions for the GUI, the GUI can select and display a record having the same feature as a learning content whose patent number is abandoned.

FIG. 10 is a diagram showing a GUI 50A different from the GUI of FIG. 9. FIG. 10 shows an efficient GUI display example for the case of handling a large number of records. Note that points of FIG. 10 different from those of FIG. 9 are described; and in the structure of the invention (or the structure in an example), the same portions or portions having similar functions are denoted by the same reference numerals in different drawings, and a repetitive description of such portions is omitted.

FIG. 10 is different from FIG. 9 in being capable of classification and display according to the record regarding the arbitrary selected classification data. In FIG. 10, display can be switched in accordance with the kind of classification data C(1) to C(4).

When the user watches the plurality of features 53 provided for the record and the judgment data of the classification model and judges that a sufficient classification precision has been obtained, the update of the classification model is terminated. When the user watches the judgment data provided for the record and judges that the classification precision is not sufficient, a learning label is provided for the record which is not provided with a user-specified label, and the classification model can be updated with the click of the icon 59. Note that a change over time of metadata included in the learning content may be predicted and the features 53 may be updated. In the case where the user updates the features 53, the classification model can include a change over time of the classification model. Thus, the user can obtain a change over time of the content classification. The classification model can get to classify contents into a group of contents whose values are expected to increase and a group of contents whose values are expected to decrease.

Although not shown, the display order of the number or label data included in the features 53, the classification data 54a to the classification data 54d, the learning label 55, the classification label 56, or the score 57 can be changed; or the selected number or label data can be sorted with a filter function so as to be displayed in a necessary order. Thus, the user can efficiently evaluate the judgment results by the classification model.

The content classification method described with reference to FIG. 1 to FIG. 10 can provide a method for classifying data having a high probability. For example, a GUI is suitable for the classification of data having a high probability. The program can update the classification model by provision of new teacher data (learning label) for the classification model. By the update of the classification model, the program can classify data having a high probability.

Furthermore, the generated classification model can be stored in a main body of an electronic device or an external memory and can be called up and used for the classification of a new file. Moreover, while new teacher data is added, the classification model can be updated in accordance with the above-described method.

The structure and method described in this embodiment can be used by being combined as appropriate with the structures and methods described in the other embodiments.

### REFERENCE NUMERALS

CL1: client computer, CL1n: client computer, CL11: client computer, CLn: client computer, DB1: database, DB2: database, LAN1: communications network, LAN2: communications network, Vlabel1: feature vector, Vlabel2: feature vector, 31: number, 32: content, 33: metadata, 34: classification data, 35: learning label, 50: GUI, 50A: GUI, 51: number, 53: feature, 54: classification data, 56: classification label, 57: score, 58a: icon, 58b: text box, 59: icon, 100: classification system, 110: GUI, 111: input portion, 112: output portion, 120: arithmetic portion, 121: data processing portion, 122: learning processing portion, 123: judgment processing portion, 130: storage portion

1. A content classification method comprising learning contents and contents,
wherein the learning contents are each provided with a first feature and a learning label,
wherein the contents are each provided with a second feature, the method comprising:
a step of generating a plurality of first classification models by machine learning using the plurality of learning contents;
a step of generating a second classification model with the use of the plurality of first classification models; and
a step of providing judgment data for the plurality of contents with the use of the second classification model and performing display on a graphical user interface.

2. A content classification method comprising learning contents and contents,
wherein the learning contents are each provided with a first feature and a learning label,
wherein the contents are each provided with a second feature, the method comprising:
a step of generating a plurality of first classification models by machine learning using the plurality of learning contents;
a step of calculating average values from outputs of the plurality of first classification models;
a step of generating a second classification model with the use of the plurality of average values; and
a step of providing judgment data for the plurality of contents with the use of the second classification model and performing display on a graphical user interface.

3. A content classification method comprising learning contents and contents,
wherein the learning contents are each provided with a first feature and a learning label,
wherein the contents are each provided with a second feature, the method comprising:
a step of generating a plurality of first classification models by machine learning using the plurality of learning contents;
a step of evaluation by the plurality of first classification models in accordance with their respective first evaluation criteria;
a step of evaluation by the plurality of first classification models in accordance with their respective second evaluation criteria;
a step of generating a second classification model from evaluation results in accordance with the plurality of first evaluation criteria and evaluation results in accordance with the second evaluation criteria; and
a step of providing judgment data for the plurality of contents with the use of the second classification model and performing display on a graphical user interface.

4. The content classification method according to claim 3,
wherein the first evaluation criteria are precision, and
wherein the second evaluation criteria are sensitivity.

5. The content classification method according to claim 1, further comprising a step of generating the first classification models with the use of any of the learning contents.

6. The content classification method according to claim 1, further comprising the steps of:
providing the learning contents with classification data; and
selecting a content having the judgment data which is the same as the classification data from the plurality of contents which are provided with classification labels with the use of an output of the second classification model and displaying the content having the judgment data on the graphical user interface.

7. The content classification method according to claim 1, wherein features provided for the learning contents and the contents are management parameters.

8. The content classification method according to claim 1, wherein the judgment data includes a classification label or a score.

9. The content classification method according to claim 8, further comprising a step in which the graphical user interface designates a particular numerical range of the score and displays a corresponding content in a list form.

10. The content classification method according to claim 2, further comprising a step of generating the first classification models with the use of any of the learning contents.

11. The content classification method according to claim 2, further comprising the steps of:
providing the learning contents with classification data; and
selecting a content having the judgment data which is the same as the classification data from the plurality of contents which are provided with classification labels with the use of an output of the second classification model and displaying the content having the judgment data on the graphical user interface.

12. The content classification method according to claim 2, wherein features provided for the learning contents and the contents are management parameters.

13. The content classification method according to claim 2, wherein the judgment data includes a classification label or a score.

14. The content classification method according to claim 13, further comprising a step in which the graphical user interface designates a particular numerical range of the score and displays a corresponding content in a list form.

15. The content classification method according to claim 3, further comprising a step of generating the first classification models with the use of any of the learning contents.

16. The content classification method according to claim 3, further comprising the steps of:
providing the learning contents with classification data; and
selecting a content having the judgment data which is the same as the classification data from the plurality of contents which are provided with classification labels with the use of an output of the second classification model and displaying the content having the judgment data on the graphical user interface.

17. The content classification method according to claim 3, wherein features provided for the learning contents and the contents are management parameters.

18. The content classification method according to claim 3, wherein the judgment data includes a classification label or a score.

19. The content classification method according to claim 18, further comprising a step in which the graphical user interface designates a particular numerical range of the score and displays a corresponding content in a list form.
